(19) United States
(12) Patent Application Publication
(10) Pub. No.: US 2008/0140656 A1
(43) Pub. Date: Jun. 12, 2008

(54) System and Method for Matching Student Job Applicants to Part-Time Job Opportunities

(76) Inventor: Jason Panda, District of Columbia, WA (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/856,857

(22) Filed: Sep. 18, 2007

Related U.S. Application Data
(60) Provisional application No. 60/873,015, filed on Dec. 6, 2006.

(51) Int. Cl. G06F 7/00

(52) U.S. Cl. 707/6; 707/E17.014

(57) ABSTRACT

A system and method for receiving and storing information about part-time employers, students and part-time jobs and matching students with part-time job opportunities based on user selected criteria, and displaying the search results in real time.

### CROSS REFERENCE TO RELATED APPLICATIONS

This application claims priority to U.S. Provisional Patent Application No. Application No 60/873,015

### FIELD OF INVENTION

This invention relates generally to the field of job search software, and more specifically to a method and system for matching student job applicants with employment opportunities

### BRIEF DESCRIPTION OF THE DRAWINGS

FIG. 1 is a diagram of a system for tracking part-time jobs, students and employers and for matching student attributes, part-time job attributes and/or employer attributes based upon user-selected criteria.

FIG. 2 is a diagram of a system for tracking employers and students and for matching student attributes, part-time job attributes and employer attributes based upon user-selected criteria, and which further includes social networking features for students.

FIG. 3 is a diagram of a system for tracking employers and students and for matching student attributes, part-time job attributes and employer attributes based upon user-selected criteria, and which further includes a feature for allowing employers to share applicant information.

FIG. 4 is a diagram of a system for tracking employers and students and for matching student attributes, part-time job attributes and employer attributes based upon user-selected criteria, and which further includes a voice and data recognition enabled device.

FIG. 5 is a flowchart of a method for tracking part-time jobs, students and employers and for matching student attributes, part-time job attributes and/or employer attributes based upon user-selected criteria.

FIG. 6 is a flowchart of a method for tracking employers and students and for matching student attributes, part-time job attributes and/or employer attributes based upon user-selected criteria, and which includes a step of calculating the proximity of jobs to universities.

FIG. 7 is a flowchart of a method for tracking employers and students and for matching student attributes, part-time job attributes and employer attributes based upon user-selected criteria, which includes a step of modifying student attributes, employer attributes and/or or part-time job attributes.

FIG. 8 is a flowchart of a method for tracking employers and students and for matching student attributes, part-time job attributes and employer attributes based upon user-selected criteria, which includes a step receiving evaluation data about part-time jobs and or employers.

FIG. 9 is a flowchart of a method for tracking employers and students and for matching student attributes, part-time job attributes and employer attributes based upon user-selected criteria, which includes a step of retrieving and sorting part-time job information obtained from other websites.

FIG. 10 is a flowchart of a method for tracking employers and students and for matching student attributes, part-time job attributes and employer attributes which includes a step of generating and collecting revenue.

### BACKGROUND

The following are terms used in connection with the system and method for matching student job applicants to part-time job opportunities described herein:

As used herein the term “applicant information” generally refers to data relating to a job applicant, including, for example, age, gender, educational level, academic history or qualifications, prior work experience, hours or times of availability, wage history, the school that the student attends, socioeconomic criteria, work samples, evaluations data, questionnaires or any other data capable of being stored, searched, retrieved or associated with other data and/or defined by a user.

As used herein the term “applicant information” tracking mechanism or “means for tracking applicant information” generally refers software, a database and/or a computer programmed to track applicant information.

As used herein, the terms “display mechanism”, “means for displaying” and “user interface” generally refers to any computer, software, database, recording device, voice and data recognition device, interface or other device or software which is designed to display at least one user selected criteria, part-time job, part-time job attribute, student, student attribute, employer or employer attribute or other data desired by a user of the method and system described herein. In other embodiments, a display mechanism or means for displaying may be an audio-informatics device, electronic communication, paper communication, print-out or other device or medium for communicating data and search results.

As used herein the term “employer” generally refers to any person, organization or entity offering a job or soliciting information from job applicants or about job applicants for an actual or contemplated part-time job opening.

As used herein the term “employer attribute” generally refers to any data relating to an employer, including, for example, wage information, geographical location, required work times, job responsibilities, prior persons who held the job, educational or academic requirements, training, expected experience or other benefits, work samples, questionnaires or any other data capable of being stored, searched, retrieved or associated with other data and/or defined by a user.

As used herein the term “evaluation data” generally refers to any data relating to the suitability of an applicant for a part-time job, or the desirability of a part-time job. Evaluation data may include information about the quality of the job experience, work environment, type of experience received, data about supervisors, educational value of the job and other information related to the part-time job experience and perceptions of the employer. Evaluation data may also include comments or student perceptions relating to the part-time job or employer. Evaluation data may further include data to assist an employer in evaluating the quality, experience, performance, satisfaction and performance of job applicants or the effectiveness of recruitment and training measures.

As used herein the term “geographical information” means information related to location and proximity of a part-time job opportunity to a college campus, university or other location of relevence selected by a student, and also information relevent to transportation to and from a part-time job. Geographical information may include but is not limted to distance from campus, public transportation access, public transportation routes, driving directions, alternative routes and costs associated with transportation to or from a part-time job.

As used herein, the term “matching mechanism” or “means for matching” generally refers to any computer, software, database, recording device, voice and data recognition device, interface or other device or software which is designed to receive, retrieve, record or store a user selected criteria, a part-time job attribute, a student attribute or employer attribute.

As used herein the term “part-time job” generally refers to hourly jobs, temporary jobs, one time jobs, internships and jobs which are typically filled by students or may be filled by students concurrently with pursuing their education.

As used herein the term “part-time job attribute” generally refers to any data relating to a part-time job including, for example, wage information, geographical location, required work times, job responsibilities, prior persons who held the job responsibility, educational or academic requirements, training, expected experience, work samples, questionnaires or any other data capable of being stored, searched, retrieved or associated with other data and/or defined by a user.

As used herein the term “part-time job search results” means a list of part-time jobs or applicants which conform to user defined or user selected criteria.

As used herein the term “real time” means the ability to access and display information at a single location within a single time session designated for searching or posting information. Such time session may be measured in minutes or hours.

As used herein, the terms “receiving mechanism” or “means for receiving” generally refer to any computer, software, database, recording device, voice and data recognition device, interface or other device or software which is designed to receive, record or store at least one user selected criteria.

As used herein, the term “social networking feature” generally refers to a web site feature which enables users to add a create a network of friends or authorized contacts on a website, forums which allow users to post questions and answers and review other users' questions and answers, groups which allow users to establish an identifiable group for receiving data, blogs which allow updating of posting information, user account pages or any analogous or functionally equivalent feature or combination of features listed herein.

As used herein, the term “student” generally refers to any person attending or living in proximity to a university.

As used herein the term “student attribute” generally refers to any data relating to a student, including, for example, age, gender, educational level, academic history or qualifications, prior work experience, hours or times of availability, wage history, the school that the student attends, socioeconomic criteria, work samples, questionnaires or any other data capable of being stored, searched, retrieved or associated with other data and/or defined by a user.

As used herein the term “user” generally refers to any person or entity that accesses, views or modified data maintained by the system and method described herein.

As used herein the terms “user selected criteria” or “user defined criteria” generally refer to any student attribute, part-time job attribute or employer attribute selected or defined by a user.

As used herein the term “voice and data recognition enabled device” is a device which allows input of data by means of the human voice.

It is desirable to have a system of posting part-time job opportunities which is convenient for employers and university students, and which allows information about part-time job opportunities to be posted and efficiently accessed in real time.

Presently students must locate part-time job opportunities from multiple sources and often geographically dispersed locations. For example, students may consult newspapers and other publications identifying job opportunities, physically go to placement offices, look for student postings or flyers on campus, or must locate and search multiple job sites and electronic databases looking specifically for part-time job opportunities. It is desirable for students to be able to locate appropriate part-time job opportunities in real time.

It is also time consuming and often frustrating for employers to post jobs to be filled by students, since employers must often research venues for posting jobs at particular campuses, make phone calls and do online research to locate appropriate placement offices and personnel, and they must invest additional time in updating and modifying such postings when positions change or have been filled. Further, employers may not know or be directed to provide all information specifically relevant to students seeking part-time jobs, which impacts the quality of applicant responses. It is desirable for employers to have a method and system for posting part-time job opportunities, modifying postings, and/or reviewing applicant information in real time.

Job tracking and posting is also burdensome for university staff and financial aid counselors. Job must be processed by staff prior to posting. Moreover, staff and faculty may have access only to the part-time job opportunities presented by business people or individuals that contact their specific school; they may not have access to postings at other universities, locations or electronic databases. Additionally, inefficiencies inherent in present systems discourage employers from posting all available part-time job openings because of the time and inconvenience they experience in posting part-time job openings.

Furthermore, it is desirable for employers to be able to utilize social networking features to attract students seeking part-time jobs to a centralized website. The social networking features can serve as a efficient and highly economical tool for part-time employers. Social networking features can also enable students and employers to efficiently exchange information relating to part-time job experiences or applicants.

University students have needs distinct from other job seekers, including but not limited to the need for flexible hours, proximity to campus, public transportation, the need to obtain relevent skills and experience, opportunities related to their academic training and opportunities consistent with their experience levels and academic goals.

Current job posting resources often do not reveal information most relevant to university students, or display all available opportunities, or enable searches based on these criteria in real time. It is desirable to enable such searches to reduce the effort required by an employer to screen and evaluate applicants, and the amount of time students spend searching for opportunities and comparing them.

It is also desirable to enable students and employers to efficiently compare and evaluate part-time opportunities and applicants using user selected criteria.

Traditional job websites, electronic databases and search engines are designed for full-time opportunities or do not distinguish between full and part-time opportunities and thus are and not adapted or designed to serve unique problems of students searching for part-time jobs. It is desirable to supplement traditional job search systems and methods to include appropriate tracking, matching or other features specifically adapted to students seeking part-time jobs and employers seeking to fill part-time jobs. Campus websites and publications contain limited postings and updating of such postings is not efficient or uniform among campuses.

### DETAILED DESCRIPTION OF DRAWINGS

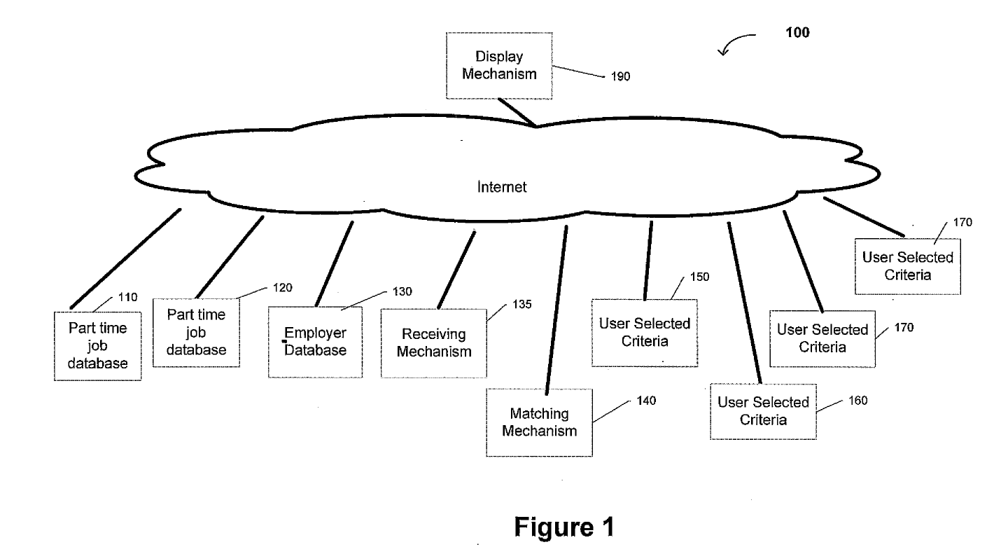

FIG. 1 is a diagram of system 100 for tracking part-time jobs, students and employers and for matching student attributes, part-time job attributes and/or employer attributes based upon user-selected criteria. System 100 includes part-time job database 110 for tracking part-time jobs, student database 120 for tracking students, and employer database 130 for tracking information about employers. Also shown in FIG. 1 is receiving mechanism 135 which is a means for receiving user selected criteria. Further shown is matching mechanism 140 which is a means for matching or relating student attributes, part-time job attributes and/or employer attributes based upon user-selected criteria 150 input by a system user. In the embodiment shown, matching mechanism 140 is software or a computer programmed to match and prioritize student attribute data 160, part-time job attribute data 170 and employer attribute data 180 which is stored in part-time job database 110, student database 120 and employer database 130. In other embodiments, information stored in part-time job database 110, student database 120 and employer database 130 may be maintained in a single database or may be stored in multiple databases in geographically disparate locations. Also shown in FIG. 1 is display mechanism 190 which is a means for displaying search results based on user-defined criteria. In the embodiment shown, display mechanism 190 is a computer interface which displays at least one least one user selected criteria, part-time job, part-time job attribute, student, student attribute, employer or employer attribute. In other embodiments, display mechanism 190 may be an audio-informatics device, electronic communication, paper communication or other device for communicating data and search results.

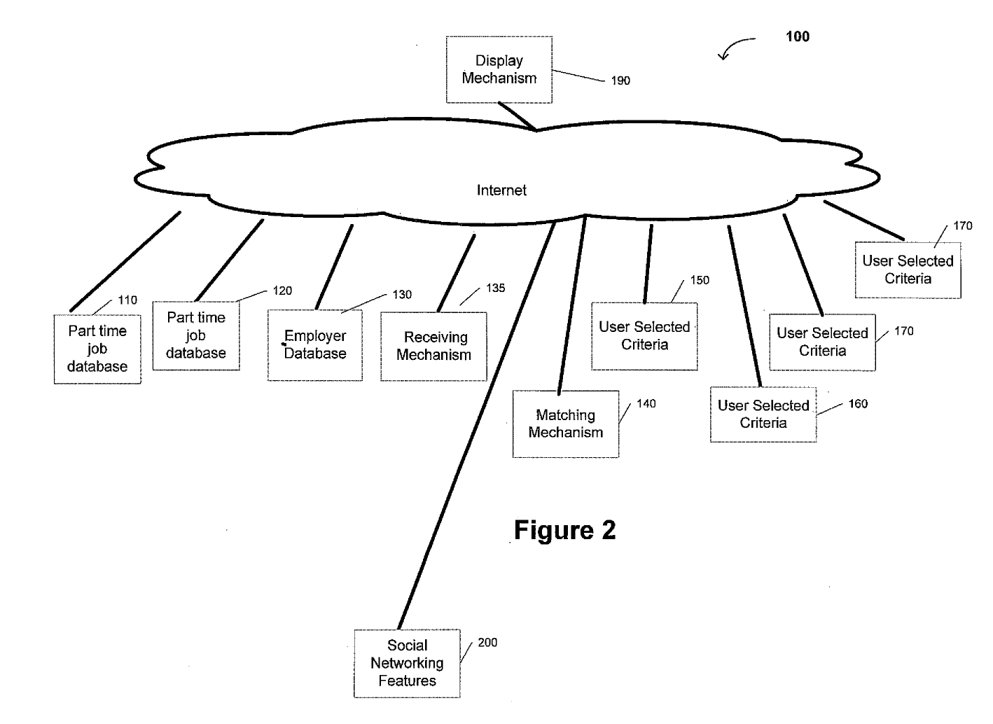

FIG. 2 is a diagram of system 100 for tracking employers and students and for matching student attributes, part-time job attributes and employer attributes based upon user-selected criteria. In the embodiment shown, system 100 further includes social networking features 200, including contact networks, forums, groups, blogs and student and employer account pages. Other embodiments may include additional social networking features, other combinations of social networking features or functionally equivalent or analogous social networking features that facilitate communication between and among students and employers, or other third parties, such as university campus personnel.

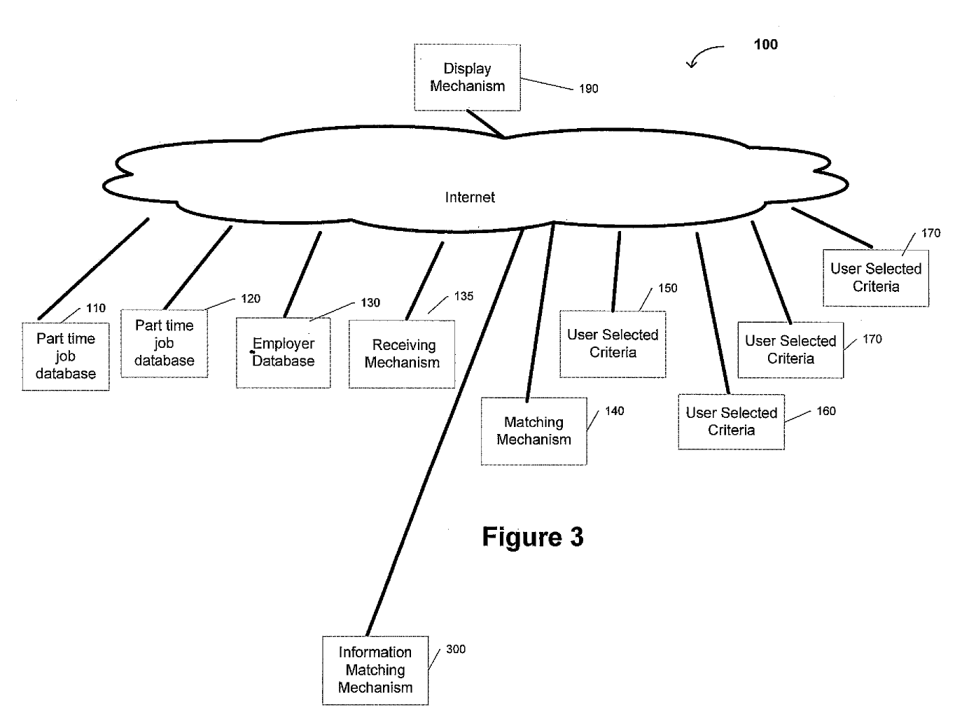

FIG. 3 is a diagram of system 100 tracking employers and students and for matching student attributes, part-time job attributes and employer attributes based upon user-selected criteria. In the embodiment shown, system 100 further includes applicant information tracking feature 300 which is a means for allowing employers to access applicant information. Such information may include interview performance, information obtained from the applicant, information obtained about the applicant from a third party or any other data which may assist an employer in a decision to hire or interview an applicant. In the embodiment shown, applicant information matching mechanism 300 is a computer programmed or configured to match applicant information to user selected criteria. Other embodiments may include software features or databases for tracking applicant information.

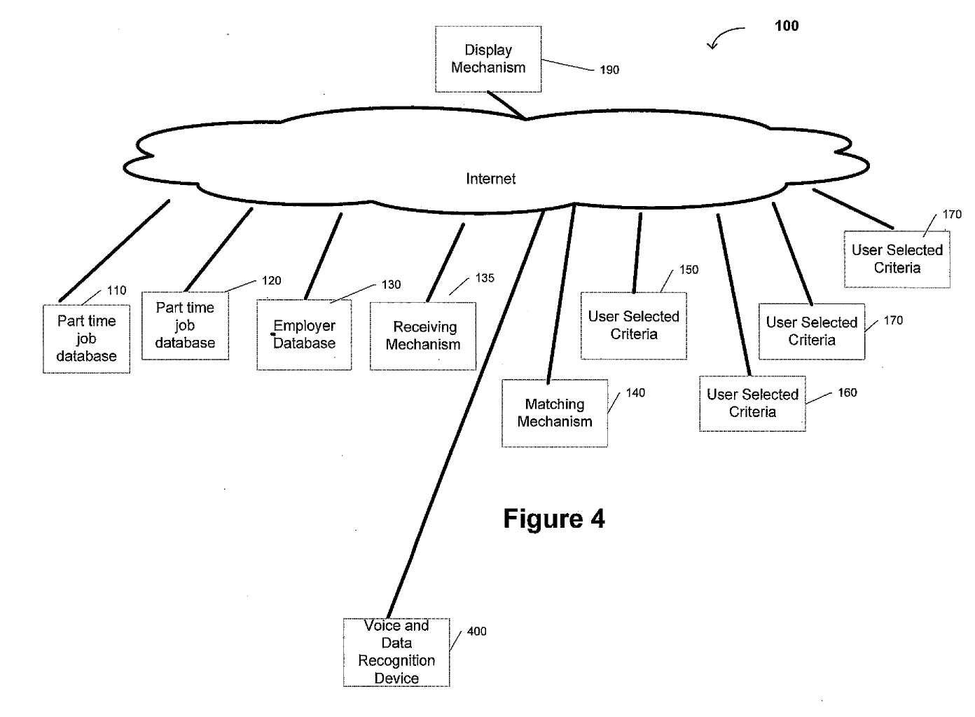

FIG. 4 is a diagram of a system 100 for tracking employers and students and for matching student attributes, part-time job attributes and employer attributes based upon user-selected criteria, and which further includes voice and data recognition enabled device 400. In the embodiment shown, employers and students use a telephone line or other digital or analog transmission device to access and/or modify employer databases, student databases and part-time job search databases. The embodiment shown includes voice activated features and/or options which may be selected on a telephone or other communication device. Other embodiments may utilize analogous types of recognition systems or include software components, which may provide additional access features and interfaces using a personal computer.

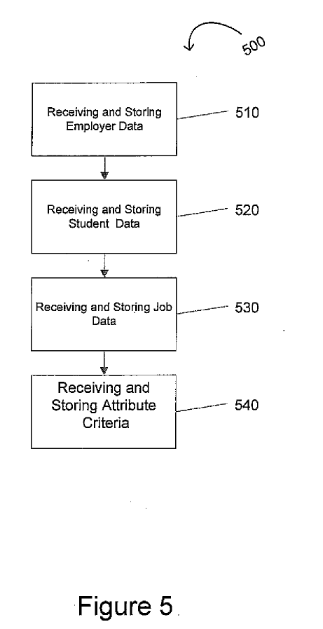

FIG. 5 is a flowchart of method 500 for matching student job applicants to part-time job opportunities which includes step 510 for receiving and storing data about at least one employer, step 520 for receiving and storing data about at least one student and step 530 for receiving and storing data about at least one part-time job. Method 500 further includes step 540 of receiving at least one user selected criteria for matching student attributes, part-time job attributes and employer attributes and step 550 of returning part-time job search results. In various embodiments, search results may be prioritized and/or displayed based on relevant criteria which may include chronology of posting, proximity to campus, wage information, qualifications or data submitted by other users.

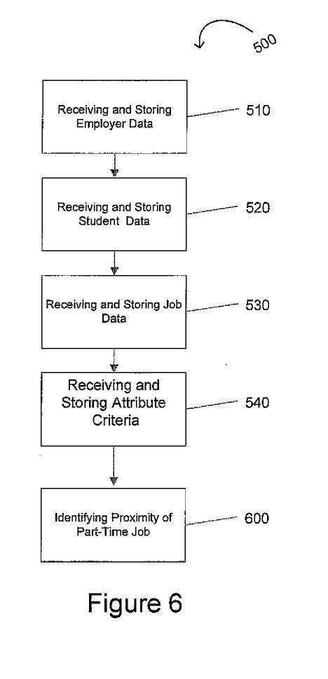

FIG. 6 is a flowchart of method 500 for matching student job applicants to part-time job opportunities which further includes step 600 of identifying the proximity of the part-time job to a university or other location specified by an applicant. In the embodiment shown, step 600 is accomplished using mapping software such as Google mapping. In some embodiments, the mapping software may be pre-loaded or programmed with defined addresses, such as the locations of campuses or schools. In other embodiments, users may specify other geographical criteria such as an address, maximum distance, neighborhood, or access to public transportation lines, or any other criteria capable of being associate or tracked by mapping software. In other embodiments, mapping software may contain fewer or more features or be omitted entirely.

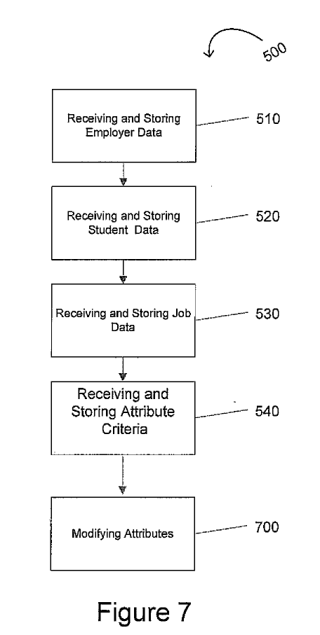

FIG. 7 is a flowchart of method 500 for tracking employers and students and for matching student attributes, part-time job attributes and employer attributes based upon user-selected criteria, which includes step 700 of modifying student attributes, employer attributes and/or or part-time job attributes. In the embodiment shown, the employers and students may add or modify information the employer database 710, student database 720 or part-time job database 730 by entering passwords. In the embodiment shown the information which may be accessed by a particular password is determined by system policies, system configuration or by a system administrator. Other embodiments may contain additional security features such as identification of data, identification of bio-informatics data or the ability to program multi-user codes and passwords having varying levels of security and user access, or may omit password protection for some or all features.

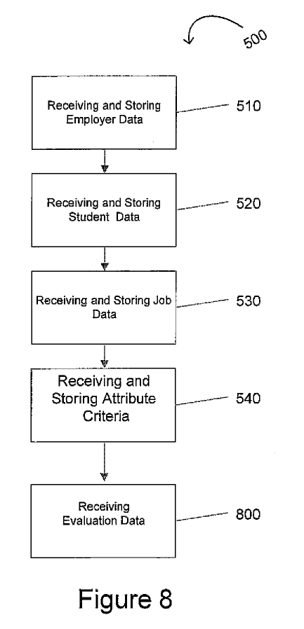

FIG. 8 is a flowchart of method 500 for matching student job applicants to part-time job opportunities, which further includes step 800 of receiving evaluation data about part-time jobs, part-time job applicants and/or employers. In the embodiment shown, step 800 allows students and/or employers to submit evaluation data about part-time jobs, applicants and/or employers. The embodiment students may also submit information about the quality of the job experience, work environment, data about supervisors, educational value about the job and other information related to the part-time job experience and perceptions of the employer. In other embodiments, additional data, comments or student perceptions relating to the part-time job or employer may also be tracked.

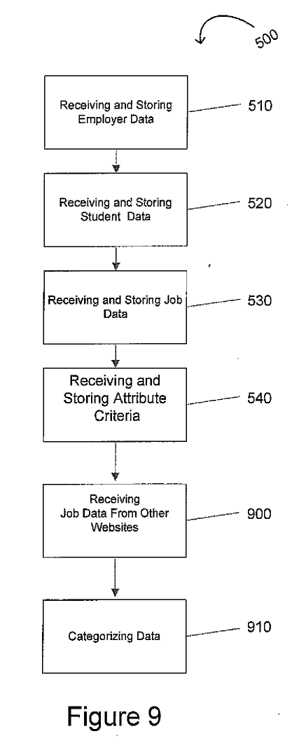

FIG. 9 is a flowchart of method 500 for matching student job applicants to part-time job opportunities, which further includes step 900 for retrieving job data from other websites and step 910 which categorizes the data obtained for inclusion in the part-time job data base and employer database. (This process is sometimes referred to as “scraping” data.) In the embodiment shown, step 900 is accomplished by the use of software which performs searches and retrieves job data from other websites and sorts and/or categorizes the data obtained for inclusion in the part-time job data base and employer database, and which further distinguishes part-time job opportunities from other opportunities.

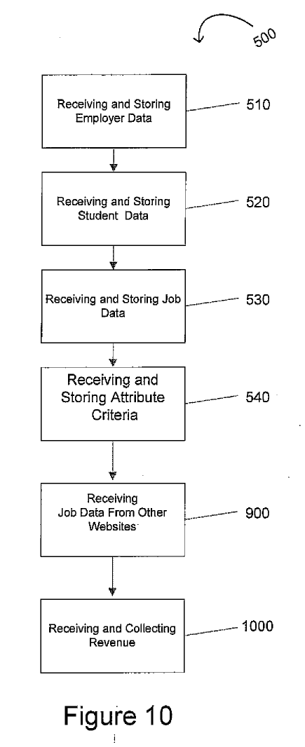

FIG. 10 is a flowchart of method 500 for tracking employers and students and for matching student attributes, part-time job attributes and employer attributes, which further includes step 1000 of generating and collecting revenue. In the embodiment shown, revenue is generated from user fees and/or advertising on the user interface. However, in other embodiments revenue may be generated by search fees, through the sale of employer, student or job information obtained, or through recruitment and other paid services that involve finding applicants having specific student attributes. Revenue may be obtained in exchange for any data or search which the system performs.

1. A system for matching students to part-time jobs comprising:
at least one part-time job database including data about at least one part-time job;
at least one part-time employer database including data about at least one part-time employer
at least one student database including data about at least one student;
a means for receiving at least one user selected criteria;
a means for matching data selected from a group consisting of student attributes, part-time job attributes and employer attributes and combinations thereof with said at least one user-selected criteria; and
a means for displaying search results selected from a group consisting of student attributes, part-time job attributes and employer attributes based upon said at least one user-selected criteria and combinations thereof.

2. The system of claim 1, wherein said system further includes a social networking feature.

3. The system of claim 1, herein said system further includes a means for tracking applicant information.

4. The system of claim 1, herein said system further includes a voice and data recognition enabled device.

5. A method of matching students to part-time jobs comprising the steps of:
receiving and storing data about at least one part-time job so that said data about at least one part-time job is capable of being searched and retrieved by identifying at least one part-time job attribute;
receiving data about at least one student so that said data about at least one student is capable of being searched and retrieved by identifying at least one student attribute;
receiving at least one user-selected criteria to define a search to match said at least one part-time job with said at least one student and displaying the results of said matching on a user interface; and
displaying a search result selected from a group consisting of said at least one student, said at least one student attribute, said at least one part-time job, said at least one part-time job attribute, at least one employer, at least one employer attribute, evaluation data and combinations thereof.

6. The method of claim 5, further including the step of receiving data about said at least one employer so that said data is capable of being searched and retrieved by identifying said at least one employer attribute.

7. The method of claim 5, further including the step of further matching data about said at least one part-time job with geographical information and displaying said geographical information on said user interface.

8. The method of claim 5, further including the step of allowing said at least one student to modify said at least one student attribute.

9. The method of claim 5, further including the step of allowing said employer to modify said at least one part-time job attribute.

10. The method of claim 5, further including the step of allowing said at least one employer to modify said at least one employer attribute.

11. The method of claim 5, further including the step of allowing said at least one student to submit part-time job evaluation data.

12. The method of claim 5, further including the step of retrieving applicant information.

13. The method of claim 5, further including the step of retrieving data about part-time jobs from job search websites.

14. The method of claim 5, further including the step of classifying data received from said job search websites.

15. The method of claim 5, further including the step of receiving revenue from users.

16. The method of claim 5, further including the step of allowing a user to access a social networking feature.

17. A method of matching students to part-time job opportunities comprising the steps of:
receiving and storing data about at least one part-time job so that said data about at least one part-time job is capable of being searched and retrieved by identifying at least one part-time job attribute;
receiving data about at least one student so that said data about at least one student is capable of being searched and retrieved by identifying at least one student attribute;
receiving at least one user-selected criteria to define a search to match said at least one part-time job with said at least one student and displaying the results of said matching on a user interface;
displaying a search result selected from a group consisting of said at least one student, said at least one student attribute, said at least one part-time job, said at least one part-time job attribute, at least one employer, at least one employer attribute and evaluation data and combinations thereof; and
matching data about said at least one part-time job with geographical information and displaying said geographical information on said user interface.

18. The method of claim 17, further including the step of receiving data about said at least one employer so that said data is capable of being searched and retrieved by identifying said at least one employer attribute.

19. The method of claim 17, further including the step of allowing said student to modify said at least one student attribute.

20. The method of claim 17, further including the step of allowing said employer to modify said at least one part-time job attribute.
